(19) United States
(12) Patent Application Publication
(10) Pub. No.: US 2026/0187907 A1
(43) Pub. Date: Jul. 2, 2026

(54) GAUSSIAN SPLAT PROXY OPTIMIZATION FOR REPRESENTATIONS

(71) Applicant: Apple Inc., Cupertino, CA (US)

(72) Inventors: Borja Morales Hernando, Sunnyvale, CA (US); Gilles M. Cadet, Agoura Hills, CA (US); Olivier Soares, Oakland, CA (US); Aman Sachan, San Francisco, CA (US); Timothy B. Henning, Sunnyvale, CA (US)

(21) Appl. No.: 19/426,420

(22) Filed: Dec. 19, 2025

Related U.S. Application Data
(60) Provisional application No. 63/739,753, filed on Dec. 30, 2024.

(51) Int. Cl. G06T 15/08; G06T 15/20; G06T 17/20

(52) U.S. Cl. CPC G06T 15/08; G06T 15/20; G06T 17/20

(57) ABSTRACT

Various implementations disclosed herein include devices, systems, and methods that provide views of a representation based on a proxy representation using three-dimensional Gaussian Splat (3DGS) data. For example, a process may include obtaining 3DGS datasets each using a plurality of splats to represent the object at a respective time associated with a first rate. The process may further include providing a first view depicting the object in a 3D environment corresponding to a first viewpoint. The process may further include generating a proxy representation of the object based on a two-dimensional texture of the first 3DGS dataset. The process may further include providing a second view depicting the object in the 3D environment using the proxy representation from a second viewpoint. The views of the object are generated at a second rate that is faster than the first rate at which the 3DGS data was generated.

### CROSS-REFERENCE TO RELATED APPLICATIONS

This Application claims the benefit of U.S. Provisional Application Ser. No. 63/739,753 filed on Dec. 30, 2024, which is incorporated herein in its entirety.

### TECHNICAL FIELD

The present disclosure generally relates to electronic devices, and in particular, to systems, methods, and devices for representing objects in computer-generated content.

### BACKGROUND

Existing techniques may not accurately or honestly present current (e.g., real-time) representations of the appearances of objects, such as users of electronic devices. For example, not showing a person's hair correctly for a realistic representation. Moreover, some techniques may be computationally expensive when rendering volumetric data for varying viewpoints. Thus, it may be desirable to provide a means of efficiently providing more accurate, honest, and/or current volumetric representations of objects, such as users (e.g., personas) as a viewpoint changes.

### SUMMARY

Various implementations disclosed herein include devices, systems, and methods that generate a view of a representation of an object, such as a user, based on three-dimensional (3D) Gaussian splatting (3DGS). Gaussian splatting is a volume rendering technique for 3D data without converting the data into primitives such as lines or surfaces. 3DGS uses a collection of three-dimensional anisotropic Gaussians, similar to point clouds in 3D, although each Gaussian is anisotropic with covariance matrix that's not necessarily diagonal. Gaussian splatting uses individual 3D points that are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, views of a time-varying object may be rendered from viewpoints that potentially vary over time, where the object is represented using a stream of 3D data having discretized volumetric form (e.g., a 30 Hz stream of 3D Gaussian splats point cloud data representing the object's changing appearance over time). Rendering the volumetric data (e.g., splats) directly may be computationally expensive and thus it may be inefficient or infeasible to re-render the object directly for different viewpoints at a fast rate (e.g., 90 Hz). To enable efficient rendering of volumetric data received at a first rate (e.g., 30 Hz) at a faster rate (e.g., 90 Hz), in an exemplary implementation, a 3D proxy representation (e.g., a textured 3D mesh, a textured heightfield, etc.) may be generated. A 3D proxy representation may be easier and faster to render than a 3D Gaussian splat representation, enabling a system to use the 3D proxy to render additional views needed to provide the views at the faster rate (e.g., for the second and third frames needed to provide views of 30 Hz content at 90 Hz as a technique to help with interpolation between frames).

In some implementations, a first texture may be generated from a current 3DGS that is used as a view for a first time (e.g., a first frame). For example, two-dimensional (2D) representations of 3DGS data may be obtained using a 2D texture mapping process. Then a 3D proxy may be generated using this texture, where the 3D proxy represents 3D positions of portions of that texture, and then the 3D proxy may be used to render subsequent (e.g., second and third) views for the corresponding current 3D viewpoint positions (e.g., providing second and third frames). In some implementations, the 3D proxy may be generated (e.g., recreated) based on each new 3DGS frame that's generated.

In some implementations, a type and/or a format of the 3D proxy may be selected depending upon rendering complexity (e.g., performance needs), viewpoint movement, gaze movement, a location and/or distance/depth of the persona, and/or other conditions or parameters. For example, the 3D proxy may be selected from and/or switched between a heightfield, a mesh such as a stereo grid mesh or a mono grid mesh, a stereo plane, a mono plane, and like.

In some implementations, a view of the user representation, such as a persona, may be provided to a viewing device (e.g., rendering a live view of a sender's persona) by generating splats corresponding to user representation data and by rendering a 3D proxy. A persona is a representation of a user, like an avatar. Advantageously, splatting avoids the need to use a mesh to avoid the appearance of holes and provides other advantages, and a proxy mesh approximation may be used to quickly render the persona from any new point of views (e.g., the viewer moves his or her gaze and or head). The 3D representations of the user at multiple instants in time may be generated on a viewing device that combines the data and uses the combined data to render views, for example, during a live communication (e.g., a virtual communication or a co-presence) session.

In some implementations, data associated with each splat of a user representation may represent a texture/color, a 3D position, direction and angle information (e.g., cone of visibility), a splat shape, a level of transparency, a covariance (e.g., how a splat is stretched/scaled), and the like. The splats may be a 3D Gaussian distribution in a 2D space with color/density (e.g., parameterization), where a person's face may be utilized as a grid, and a number of splats may be determined based on a ray off the face/grid. The grid/parameterization of the splat distribution provides higher quality data, may be faster to train a machine learning model, and may provide faster (e.g., real-time) rasterization. In some implementations, 3D mapping information (e.g., identifying x,y,z positions corresponding to UV coordinates of a UV map) may be generated at enrollment (e.g., Gaussian UV maps).

In general, one innovative aspect of the subject matter described in this specification can be embodied in methods that include the actions of, at a processor of a device, obtaining three-dimensional Gaussian Splat (3DGS) data representing an object, wherein the 3DGS data includes 3DGS datasets each using a plurality of splats having three-dimensional (3D) positions to represent the object at a respective time of a plurality of times associated with a first rate at which the 3DGS data was generated, wherein a first 3DGS dataset corresponds to a first time of the plurality of times. The actions may further include providing a first view depicting the object in a 3D environment, the first view corresponding to a first viewpoint in the 3D environment and splats of the first 3DGS dataset. The actions may further include generating a proxy representation of the object based on a two-dimensional (2D) texture and the 3D positions of splats associated with the first 3DGS dataset, the 2D texture generated based on the first 3DGS dataset and corresponding to an appearance of the object from the first viewpoint in a 3D environment. The actions may further include providing a second view depicting the object in the 3D environment, wherein the second view is provided by depicting the proxy representation from a second viewpoint in the 3D environment, wherein the first view and second view provide views of the object in the 3D environment at a second rate that is faster than the first rate at which the 3DGS data was generated.

These and other embodiments can each optionally include one or more of the following features.

In some aspects, generating the proxy representation of the object includes selecting a proxy rendering approach based on determining a complexity level associated with rendering a view of the object. In some aspects, selecting the proxy rendering approach is based on determining at least one of a proxy type and a proxy format for depicting the proxy representation.

In some aspects, the proxy representation is generated based on the second viewpoint. In some aspects, the proxy representation is a 3D mesh.

In some aspects, the actions further include adjusting a density of a set of vertices in at least a portion of the 3D mesh based on a gaze direction. In some aspects, the actions further include updating the proxy representation of the object based on image quality associated with the second view depicting the object in the 3D environment. In some aspects, the actions further include updating the proxy representation of the object based on detecting motion of the device with respect to a movement threshold.

In some aspects, the generated proxy representation of the object includes a first eye representation and a second eye representation.

In some aspects, the proxy representation of the object is generated based on one or more proxy parameters corresponding to a proxy generation technique. In some aspects, the one or more proxy parameters corresponding to the proxy generation technique includes a proxy criterion associated with a resolution of the proxy representation of the object. In some aspects, the one or more proxy parameters corresponding to the proxy generation technique includes one or more proxy levels. In some aspects, the one or more proxy levels include a stereo grid mesh, a stereo plane, a mono grid mesh, and a mono plane. In some aspects, the one or more proxy parameters corresponding to the proxy generation technique includes a proxy criterion associated with a proxy update rate corresponding to the second rate.

In some aspects, providing the second view of the object in the 3D environment by depicting the proxy representation in the 3D environment is based on a variable resolution map, wherein a first portion of the second view of the object is a different resolution than a second portion of the second view.

In some aspects, the object includes a face portion and an additional portion of a user. In some aspects, the proxy representation of the object is a 3D representation.

In some aspects, providing the first view depicting the object is based on 3D point cloud points associated with distribution data defining sizes and shapes for rendering the 3D point cloud points as the splats of the first 3DGS dataset.

In some aspects, each 3DGS dataset includes at least one of position information, color information, covariance information, transparency information, an orientation, opacity information, extent information in each axis, rotation data, a scale, and semantic information. In some aspects, the device is a viewer's device, wherein the 3DGS data is obtained during a communication session with a sender's device associated with the proxy representation of the object.

In some aspects, the 3DGS data is generated and updated during an enrollment process based on images of a face of a user captured while the user is expressing a plurality of different facial expressions. In some aspects, a splat generation technique generates the 3DGS data via a machine learning model trained using training data obtained via one or more sensors in one or more environments.

In some aspects, providing the first view and the second view for depicting the object in the 3D environment includes displaying a representation of the object in an extended reality (XR) environment. In some aspects, the 3DGS data is obtained in a first physical environment, and the views depicting the object in the 3D environment is displayed in a view of a second physical environment that is different than the first physical environment.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining sensor data from a user according to some implementations.

FIG. 2 illustrates exemplary electronic devices operating in different physical environments during a communication session of a first user at a first device and a second user at a second device with a view of a combined three-dimensional (3D) representation of the second user for the first device in accordance with some implementations.

FIGS. 3A-3D illustrate examples of 3D Gaussian splats for use with generating views of 3D representations in accordance with some implementations.

FIG. 4 illustrates an example of generating and displaying a stereo view of splats on a device in accordance with some implementations.

FIGS. 5A-5D illustrate examples of a proxy representation with respect to a view of splats as illustrated in FIG. 4 in accordance with some implementations.

FIG. 6 illustrates an example of generating a representation of a user by rendering proxy representations for additional viewpoints based on 3DGS data rendered from a first viewpoint in accordance with some implementations.

FIGS. 7A-7C illustrate adjusting a set of vertices of a portion of a proxy mesh based on gaze in accordance with some implementations.

FIG. 8 is a flowchart representation of a method for providing views of a representation by rendering a proxy representation for a second viewpoint based on 3DGS data rendered from a first viewpoint in accordance with some implementations.

FIG. 9 is a block diagram illustrating device components of an exemplary device according to some implementations.

FIG. 10 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

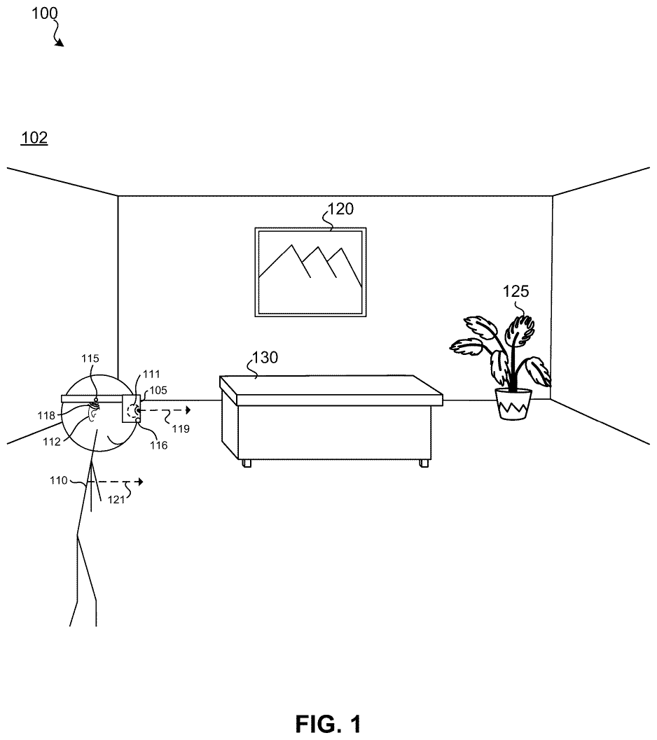

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, the illumination source of the device 105 may emit NIR light to illuminate the eyes of the user 110 and the NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding or a scene understanding based on sensor data obtained by a user worn device, such as first device 105. Such a user understanding may be indicative of a user state that is associated with providing user assistance or facilitating a communication session. In some example, a user's appearance or behavior or an understanding of the environment (scene understanding) may be used to recognize a need or desire for assistance so that such assistance can be made available to the user. For example, based on determining such a scene understanding, augmentations may be provided to assist the user by enhancing or supplementing the user's abilities, e.g., information about an environment to a person. Additionally, a user understanding and/or a scene understanding may be utilized to customize a viewing experience, e.g., selecting a rendering mode, which will be further discussed herein.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

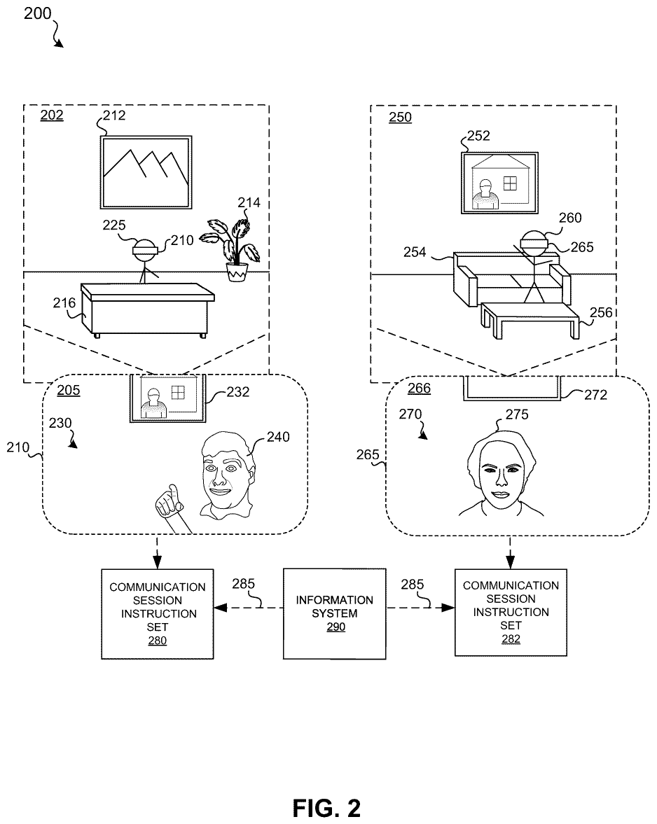

FIG. 2 illustrates exemplary electronic devices operating in different physical environments during a communication session of a first user at a first device and a second user at a second device with a view of a 3D representation of the second user for the first device in accordance with some implementations. In particular, FIG. 2 illustrates exemplary operating environment 200 of electronic devices 210, 265 operating in different physical environments 202, 250, respectively, during a communication session, e.g., while the electronic devices 210, 265 are sharing information with one another or an intermediary device such as a communication session system/server. In this example of FIG. 2, the physical environment 202 is a room that includes a wall hanging 212, a plant 214, and a desk 216 (e.g., physical environment 102 of FIG. 1). The electronic device 210 includes one or more cameras, microphones, depth sensors, or other sensors that can be used to capture information about and evaluate the physical environment 202 and the objects within it, as well as information about the user 225 of the electronic device 210. The information about the physical environment 202 and/or user 225 may be used to provide visual content (e.g., for user representations) and audio content (e.g., for audible voice or text transcription) during the communication session. For example, a communication session may provide views to one or more participants (e.g., users 225, 260) of a 3D environment that is generated based on camera images and/or depth camera images of the physical environment 202, a representation of user 225.

Additionally, in this example of FIG. 2, the physical environment 250 is a room that includes a wall hanging 252, a sofa 254, and a coffee table 256. The electronic device 265 includes one or more cameras, microphones, depth sensors, or other sensors that can be used to capture information about and evaluate the physical environment 250 and the objects within it, as well as information about the user 260 of the electronic device 265 (e.g., a user worn device or HMD device, such as device 105). The information about the physical environment 250 and/or user 260 may be used to provide visual and audio content during the communication session. For example, a communication session may provide views of a 3D environment that is generated based on camera images and/or depth camera images (from electronic device 265) of the physical environment 250 as well as a representation of user 260 based on camera images and/or depth camera images (from electronic device 265) of the user 260. For example, a 3D environment may be sent by the device 210 by a communication session instruction set 280 in communication with the device 265 by a communication session instruction set 282 (e.g., via the information system 290 via network connection 285). The information system 290 may orchestrate the encryption/decryption and pre-downloading of an asset (e.g., 3D asset data, such as data associated with user representations 240, 275) between two or more devices (e.g., electronic devices 210 and 265).

FIG. 2 illustrates an example of a view 205 of a virtual environment (e.g., 3D environment 230) at device 210, where a representation 232 of the wall hanging 252 and a user representation 240 is provided (e.g., a persona of user 260), provided there is a consent to view the users'representations of each user during a particular communication session. In particular, the user representation 240 of user 260 is generated based on one or more user representation techniques for a more realistic persona generated in real time. The generation of user representations is further discussed herein.

Additionally, the electronic device 265 within physical environment 250 provides a view 266 that enables user 260 to view representation 272 of the wall hanging 212 and a representation 275 (e.g., a persona) of at least a portion of the user 225 (e.g., from mid-torso up) within the 3D environment 270. In other words, the user representation 240 of user 260 is generated at device 210 by generating combined 3D representations of the user 260 for the multiple instants in a period of time based on data obtained from device 265 (e.g., a frame-specific 3D representation of user 260). Alternatively, in some embodiments, user representation 240 of user 260 is generated at device 265 (e.g., sending device of a speaker) and sent to device 210 (e.g., viewing device to view a persona of the speaker). In some embodiments, each of the 3D representations 240 of user 260 and 275 of user 225 is generated by generating splats corresponding to user representation data and selected from among multiple sets of splats based on a context of a viewing experience according to techniques described herein.

In the example of FIG. 2, the electronic device 210 and electronic device 265 is illustrated as a head-mounted device (HMD). However, either of the electronic devices 210 and 265 may be a mobile phone, a tablet, a laptop, so forth, or like electronic device 265, may be worn by a user (e.g., head-worn device (glasses), headphones, an ear mounted device, and so forth). In some implementations, functions of the devices 210 and 265 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 210 and 265 may communicate with one another via wired or wireless communications. In some implementations, each device communicates with a separate controller or server to manage and coordinate an experience for the user (e.g., a communication session server). Such a controller or server may be located in or may be remote relative to the physical environment 202 and/or physical environment 250.

Additionally, in the example of FIG. 2, the 3D environments 230 and 270 are XR environments that are based on a common coordinate system that can be shared with other users (e.g., a virtual room for personas for a multi-person communication session). In other words, the common coordinate system of the 3D environments 230 and 270 are different than the coordinate system of the physical environments 202 and 250, respectively. For example, a common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 225 or 260 may be generated based on a combination of live images and prior images of the user. The prior images may be used to generate portions of the representation for which live image data is not available (e.g., portions of a user's face that are not in view of a camera or sensor of the electronic device 210 or 265 or that may be obscured, for example, by a headset or otherwise). In one example, the electronic devices 210 and 265 are HMDs and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

In some implementations, generating one or more user representations for a communication session as illustrated in FIG. 2 (e.g., generating user representation 240, 275), may be based on one more rendering techniques, such as using a 3D mesh or a 3D point cloud. However, techniques described herein utilize a 3D gaussian splat rendering approach using UV mapping and generating a proxy mesh representation. Several advantages may be realized using a simple set of values with depth values defined relative to multiple points as expressed by 3D Gaussian splats using UV mapping. The set of values may require less computation and bandwidth than using a 3D mesh or 3D point cloud, while enabling a more accurate user representation than an RGBDA image. Moreover, the set of values may be formatted/packaged in a way that is similar to existing formats, e.g., RGBDA images, which may enable more efficient integration with systems that are based on such formats.

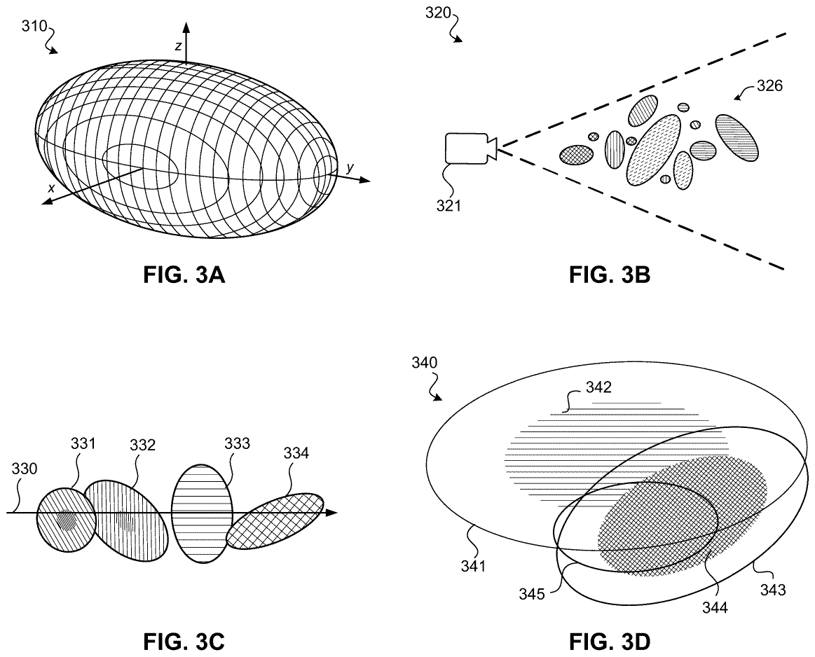

FIGS. 3A-3D illustrate examples of 3D Gaussian splats for use with generating views of 3D representations in accordance with some implementations. For example, 3D Gaussian Splatting (3DGS) may be used for 3D modeling to represent complex scenes as a combination of a large number of colored 3D Gaussians which are rendered into camera views via splatting-based rasterization. The positions, sizes, rotations, colors and opacities of these Gaussian splats can then be adjusted via differentiable rendering and gradient-based optimization such that they represent the 3D scene given by a set of input images.

FIG. 3A illustrates a 3D Gaussian splat 310, e.g., an ellipsoid shape formed by a 3D gaussian distribution. The 3D Gaussian splat 310 may be used to represent a position (μ), such as xyz coordinates. The 3D Gaussian splat 310 may be used to represent direction and angle information for a cone of visibility. The 3D Gaussian splat 310 may further represent rotation and scale (e.g., Σ: covariance matrix), opacity (α), color (e.g., RGB values), anisotropic covariance, and spherical harmonic (SH) coefficients. FIG. 3B illustrates an environment 320 for rendering splats 326 based on a visibility direction of a camera 321. FIG. 3C illustrates ordering the splats along a camera look-at direction along a ray 330. For example, the splats 331, 332, 333, 334 are identified and ordered along the ray 330. For example, Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints. FIG. 3D illustrates an environment 340 for blending splats 341, 342, 343, 344, 345 that may be viewed along the ray 330 direction from the camera view by composing the splats 331, 332, 333, 334 on an image plane. Some implementations may use screen-to-splats (e.g., similar to ray-casting techniques), splats-to-screen (e.g., similar to projection techniques), a combination thereof, or other techniques for composing splats.

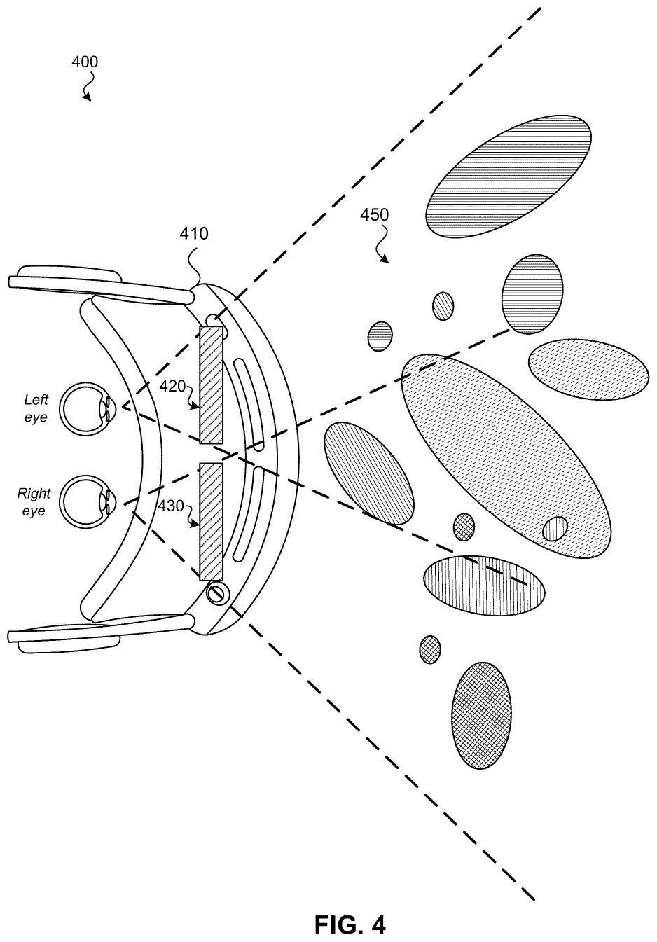

FIG. 4 illustrates an example environment 400 for generating and displaying a stereo view of splats on a device (e.g., an HMD) in accordance with some implementations. For example, the device 410 is an HMD that includes a first display 420 for a left eye view and a second display 430 for a right eye view. The first display 420 and the second display 430 may then view the rendered splats 450 for each respective viewpoint accordingly. In some implementations, the generated images for each viewpoint may be rendered as a single mono image (e.g., render for one eye), or the images may be presented as a stereo view, as illustrated in FIG. 4.

In some implementations, culling techniques for selecting a subset of the splat data for rendering a stereo view may be applied in a similar technique described herein for each eye separately, or maybe applied as culling for the overall viewer's FoV, gaze, and/or occlusions based on the viewpoint. For example, a particular splat for a left eye viewpoint may be occluded, and thus not selected to be rendered, but that same splat for a right eye viewpoint may need to be rendered to avoid any holes/gaps from the rendering for the right eye viewpoint. Alternatively, in some implementations, if only one right eye or left eye viewpoint requires that a particular splat needs to be rendered, then the system described herein will render that splat for both viewpoints to avoid any mismatches or voids for the overall stereo view of the viewer.

In some implementations, the generated images for each viewpoint may be rendered as a single mono grid mesh, a combination of stereo grid meshes, and the like, as examples of a proxy representation. A proxy representation, as described herein, may be generated and used to render additional views needed to provide views at the faster rate than compared to generating 3D Gaussian splats. For example, views of a time-varying object may be rendered from viewpoints that potentially vary over time, where the object is represented using a stream of 3D data having discretized volumetric form (e.g., a 30 Hz stream of 3D Gaussian splats point cloud data representing the object's changing appearance over time). Rendering the volumetric data (e.g., splats) directly may be computationally expensive and thus it may be inefficient or infeasible to re-render the object directly for different viewpoints at a fast rate (e.g., 90 Hz). To enable efficient rendering of volumetric data received at a first rate (e.g., 30 Hz) at a faster rate (e.g., 90 Hz), a proxy representation (e.g., a textured 3D mesh, a textured heightfield, etc.) may be generated. In some implementations, a 3D proxy may be generated using a texture (e.g., a 3D texture based on a 2D texture mapping process), where the 3D proxy represents 3D positions of portions of that texture, and then the 3D proxy may be used to render subsequent (e.g., second and third) views for the corresponding current 3D viewpoint positions (e.g., providing second and third frames). In some implementations, the 3D proxy may be generated (e.g., recreated) based on each new 3DGS frame that's generated.

In some implementations, a proxy representation may be easier and faster to render than a 3D Gaussian splat representation, enabling a system to use the 3D proxy to render additional views needed to provide the views at the faster rate (e.g., for the second and third frames needed to provide views of 30 Hz content at 90 Hz as a technique to help with interpolation between frames). In some implementations, a type and/or a format of the 3D proxy may be selected depending upon rendering complexity (e.g., performance needs), viewpoint movement, gaze movement, a location and/or distance/depth of the persona, and/or other conditions or parameters. For example, the 3D proxy may be selected from and/or switched between a heightfield, a mesh such as a stereo grid mesh or a mono grid mesh, a stereo plane, a mono plane, and like.

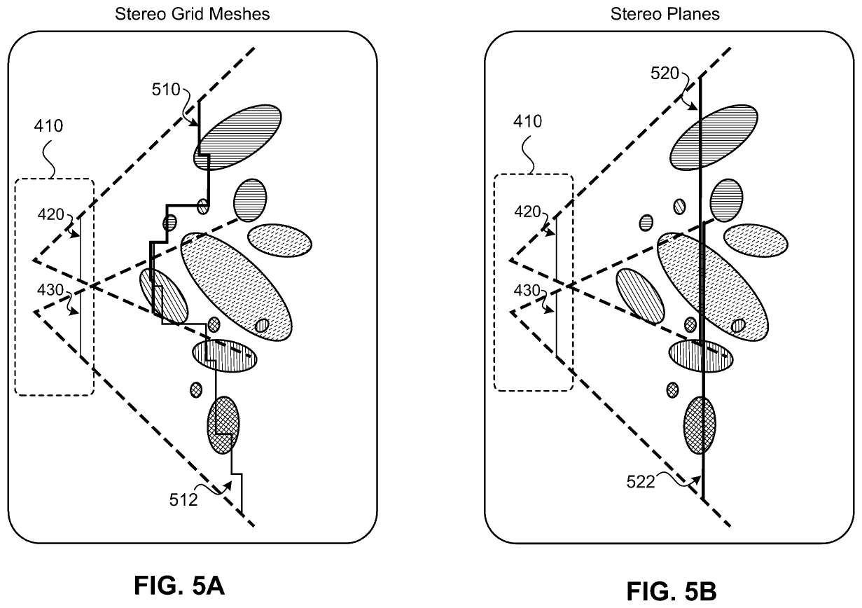

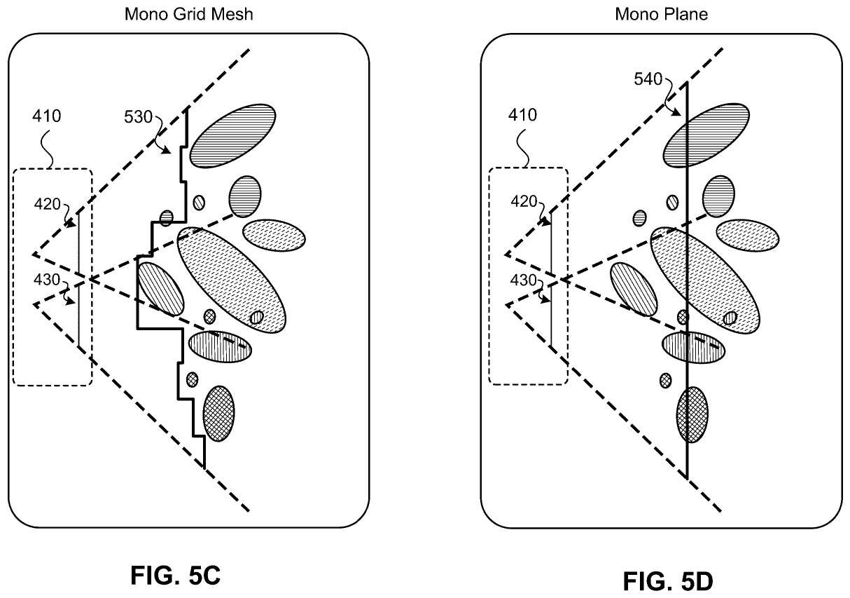

FIGS. 5A-5D illustrate examples of different proxy representations with respect to a view of rendered splats as illustrated in FIG. 4 in accordance with some implementations. For example, depending on the rendering optimization requirements for a particular rendering, one or more of the different proxy representations illustrated in FIGS. 5A-5D be utilized during a rendering process.

FIG. 5A illustrates a stereo grid mesh proxy representation that includes a left eye grid mesh 510 for a left eye view and a right eye grid mesh 512 for a right eye view. For example, a stereo grid mesh proxy representation may be a higher quality resolution and may be used to provide a viewer a good perception of depth with limited reprojection error. A stereo grid mesh proxy representation may be utilized for generating representations that are within a field of view of a viewer (e.g., not on a side or peripheral vision of a viewer) and are within a close proximity to a viewer (e.g., a view of a persona less than two meters from a viewer).

FIG. 5B illustrates a stereo plane proxy representation that includes a left eye plane 520 for a left eye view and a right eye plane 522 for a right eye view. A stereo plane proxy representation may be used for generating representations that are within a field of view of a viewer (e.g., not on a side or peripheral vision of a viewer), but are not within a close proximity to a viewer (e.g., a view of a persona greater than two meters from a viewer). For example, a stereo plane proxy representation of FIG. 5B may be lower quality resolution than the stereo grid mesh proxy representation and may be used to still provide a viewer a good perception of depth (e.g., stereo view), but a stereo plane representation may include more reprojection errors than compared to the stereo grid proxy representation of FIG. 5A because the stereo planes may not accurately represented the different splats as accurately as a grid mesh.

FIG. 5C illustrates a mono grid mesh proxy representation that includes a mono grid mesh 530 for a left eye view and a right eye view. A mono grid mesh proxy representation may be used for generating representations that are on the side or in a peripheral vision of a viewer, but are within a close proximity to a viewer (e.g., less than two meters). For example, a mono grid mesh proxy representation of FIG. 5C may be lower quality resolution than the stereo grid or stereo plane proxy representations, but a mono grid mesh proxy representation may be used to provide an increase in performance (e.g., easier to render) and may include less reprojection errors than compared to the stereo plane proxy representation of FIG. 5B because the stereo planes may not accurately represent the different splats as accurately as a grid mesh

FIG. 5D illustrates a mono plane proxy representation that includes a mono plane 540 for a left eye view and a right eye view. A mono plane proxy representation may be used for generating representations that are on the side or in a peripheral vision of a viewer, and are not within a close proximity to a viewer (e.g., greater than two meters). For example, a mono plane proxy representation of FIG. 5D may be lower quality resolution than the stereo grid or stereo plane proxy representations, but a mono plane proxy representation may be used to provide an increase in performance (e.g., easier to render) than compared to any of the other proxy representations because the mono planes may not accurately represent the different splats as accurately as a stereo or mono grid mesh or require two plane renderings as a stereo plane.

In some implementations, according to some proxy generation techniques described herein, based on a complexity of the rendering, the different proxy representations for FIGS. 5A-5D may be utilized as the complexity changes or as other conditions change. For example, the rendering could start with stereo mesh (FIG. 5A), then go to mono mesh (FIG. 5C), then go to a mono plane in order to just render one eye (FIG. 5D). The complexity of a rendering of a persona may change based on different viewpoints of the viewer or the movement of the persona. The optimization of selecting a particular proxy representation may be based on one or more parameters such as resolution, depth, reprojection errors, certain conditions of the rendering (e.g., a distance of a persona to a viewer), and the like. For example, the persona may move closer or further away from a viewer's viewpoint and based on a viewing threshold (e.g., two meters of the viewers point of view), the proxy generation techniques may change.

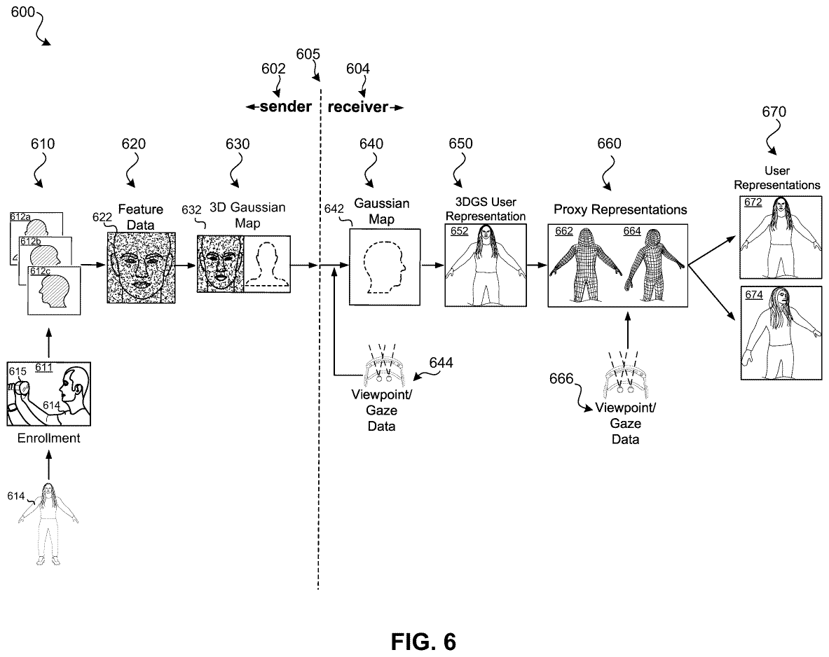

FIG. 6 illustrates an example of generating a representation of a user (e.g., a persona) by rendering proxy representations for additional viewpoints based on 3DGS data rendered from a first viewpoint in accordance with some implementations. In particular, FIG. 6 illustrates an example user representation process 600 for obtaining enrollment data from an enrollment process 610 (e.g., enrollment images 612a,b,c) from a sending device for a sender and a viewpoint at a receiving device for a viewer to generate a view of a user representation 662 (e.g., a persona) using a Gaussian splatting and proxy mesh rendering technique. Moreover, the example rendering process of user representation process 600 of FIG. 6 illustrates a data flow process between the sending device (e.g., sender phase 602) and the receiving device (e.g., receiver phase 604) as illustrated by the send/receive timeline mark 605.

Enrollment process 610 illustrates images of a user 614 during an enrollment process. An enrollment process 610 may include a user enrollment registration (e.g., preregistration of enrollment data) and obtaining sensor data (e.g., live data enrollment). The user enrollment registration, as illustrated in image 611, may include a user 614 obtaining a full view image of his or her face using external sensors on the device 615 (e.g., device 105), and therefore, would take off and orient the device 615 (e.g., an HMD) towards his or her face during an enrollment process. The enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user while the user is providing the enrollment images to get a visualization of the status of the enrollment process. The enrollment image data 610 may include an enrollment personification with different user expressions and from different viewpoints (e.g., a front view in enrollment image 612a, a right side view in enrollment image 612b, and a left side view in enrollment image 612c). In some examples, more or less different expressions and/or viewpoints may be utilized to acquire sufficient data for the enrollment process.

In some implementations, a transformation of the enrollment image data to feature data 622 may occur by transforming (e.g., via a transformer) as part of a feature data process 620. For example, feature data 622 may include learned feature information of the user 614 obtained from the enrollment images, such as skin, color, and other semantic information per pixel. The feature data 622 may include a list of positions for each feature value (e.g., 14 feature channels). The feature data 622 may then be decoded by a decoder to generate 3D Gaussian maps for each feature as part of the Gaussian map process 630. The 3D points of the feature data may be mapped to Gaussian parameters of a UV map (e.g., 3D points+Gaussian parameters) to generate multiple 3D Gaussian maps as 3D Gaussian map data 632 to be rendered by a specific splat generation technique (e.g., model/parameters specifying total number of splats, splat size attributes, etc. for different resolutions). For example, a UV map stores the x,y,z positions for the splat parameters (e.g., direction and angle information (cone of visibility information), color (view dependent/harmonics information), covariance, alpha/transparency, orientation, opacity, extent in each axis, rotation, scale, semantic information (e.g., skin, hair, cheek, nose, lips, eyebrow, etc.). In other words, the Gaussian map process 630 may obtain 3D point information that includes sufficient information that which splat generation can be generated (e.g., 3D vector projections).

In some implementations, the process 600 proceeds after generating the 3D Gaussian map data 632 from the Gaussian UV map process 630 (e.g., at a sender's device after enrollment), the system (e.g., at viewer's device) may obtain the 3D Gaussian map data 632 (e.g., the feature data mapped to Gaussian parameters via a UV map) and project the Gaussian data using a current viewpoint (e.g., viewpoint data 644) to determine 2D Gaussian map data 642 (e.g., 2D points+Gaussian parameters) for the Gaussian map process 640 at a receiving device. In other words, a receiving device may obtain multiple sets of splats that include splat parameter data defining characteristics of a plurality of 3D splats that may be rendered at the 3DGS user representation rendering process 650 to generate the user representation 652 for a first/current viewpoint.

In some implementations, a proxy representation process 660 obtains the data from the 3DGS user representation 652, obtains additional viewpoint data 666, and generates one or more proxy representations 662, 664, etc. For example, a proxy representation process may generate a 3D proxy representation of an object (e.g., a persona of a person), using a textured 3D mesh, a textured heightfield, or the like. The 3D proxy representation may be easier and faster to render than a 3D Gaussian splat representation, enabling the proxy representation system of process 600 to use the 3D proxy to render additional views needed to provide the views at the faster rate than 3D Gaussian splat representations (e.g., for the second and third frames needed to provide views of 30 Hz content at 90 Hz).

Then a rendering process 670 generates user representations 672 and 674 for different viewpoints based on the proxy representations 662, 664, etc. For example, the 3DGS user representation 652 may be generated at 30 hz, but the display frame rate is 90 hz. Thus, the proxy representation process 660 may be used to generate a 3D proxy representation (e.g., a textured 3D mesh, a textured heightfield, etc.) that is easier to render and uses this 3D proxy representation to render the additional views needed to provide the views at the faster rate (e.g., for the second and third frames needed to provide views of 30 Hz content at 90 Hz). The rendering of each user representation 652, 672, 674, etc. for the user 614 is illustrated as a user representation (e.g., a persona), but the Gaussian splatting techniques and proxy representation rendering techniques described herein may be used for any object or 3D scene reconstruction.

In some implementations, the splat rendering approach and proxy representation rendering techniques for generating the different user representations 652, 672, 674, etc. may vary and may be adjusted based on resolution, different size of splats, different colors or less color spectrums, different number of gaussians rendered along a viewing ray 330, or a combination thereof. For example, as illustrated in FIG. 3C, a high resolution splat rendering technique can render more gaussian splats along the viewing ray 330 while a lower resolution can render maybe only the first and/or second splat. In some implementations, a lower resolution splat rendering technique may use proxy rendering such as a stereo grid mesh (FIG. 5A), a stereo plane (FIG. 5B), a mono grid mesh (FIG. 5C), a mono plane (FIG. 5D), and the like. In some implementations, the 3D proxy may be generated (e.g., recreated) based on each new 3DGS frame that's generated.

The various implementations discussed herein for each splat rendering technique to generate different versions of quality of representations (e.g., low to high resolution) are merely exemplary and is not meant to be limiting. For example, other embodiments may have more or less than three different levels of resolution (e.g., low, medium, high, etc.), and some embodiments may not have discrete levels and may have a continuous, sliding bar approach that may be adjusted based on the complexity and/or context of the viewing experience as it may change frame-to-frame. For example, the persona may move closer within the view requiring higher resolution or move farther away requiring lower resolution. Furthermore, adapting the rendering techniques for generating a proxy representation corresponding to the complexity and/or context of the viewing experience may be based on movement of the user's head and/or gaze.

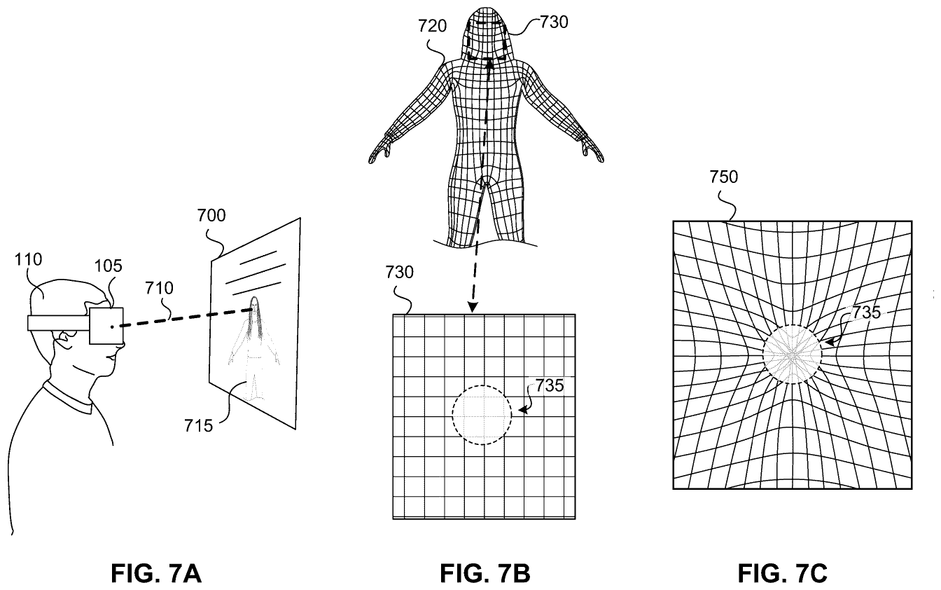

FIGS. 7A-7C illustrate adjusting a set of vertices of a portion of a proxy mesh based on gaze in accordance with some implementations. FIG. 7A illustrates an exemplary interaction of a user 110 wearing the device 105 (e.g., an HMD), while the user 110 is looking with a gaze along the path 710 at a user representation 715 on a user interface 700. In this example, the user 110 is using device 105 to view and interact with an XR environment that includes the user interface 700 (e.g., a user participating in a communication session with another user represented by a persona—user representation 715). The user representation 715 may be generated initially for a first viewpoint using 3DGS, but then updated by rendering proxy representations of the 3DGS data as illustrates in FIG. 7B. FIG. 7B illustrates a gaze location 735 upon the proxy representation 720 as the user is looking at a user representation 715 in FIG. 7A, as shown at the area 730. FIG. 7C illustrates controlling vertex sensitivity by adjusting (e.g., warping) a set of vertices at or proximate to the identified gaze location 735.

For example, in various implementations, a proxy representation may be a 3D mesh (e.g., proxy representation 720) and a density of a set of vertices may be adjusted in at least a portion of the 3D mesh based on a gaze direction (e.g., a gaze along the path 710). In other words, adjusting the density of vertices to control vertex sensitivity of the mesh to focus on where a viewer is gazing (e.g., as you get further away from a gaze center, then less vertex sensitivity is needed). For example, as illustrated in FIGS. 7A-7C, vortex animation may be adjusted based on determining a gaze center (e.g., looking at a view of a face of the user representation 715). Based on the determining the center of a gaze of a viewer (e.g., user 110), then more vertices may be added at the center of the gaze and project that on a persona. In some implementations, the 3D proxy mesh is not adding a vertex, but the vertices may be warped more towards the gaze center, as illustrated in FIG. 7C. For example, since there are a million pixels for personas, this process may reduce those calculations such that in between regions of grid, and the system may perform some linear interpolation (or other technique/calculation) to determine what the value should be in those areas.

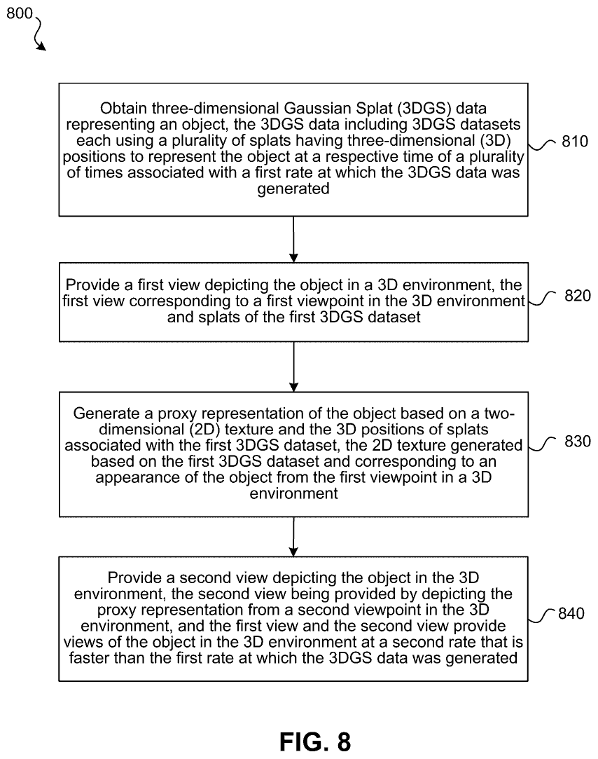

FIG. 8 is a flowchart illustrating an exemplary method 800. In some implementations, a device (e.g., device 105 of FIG. 1) performs the techniques of method 800 to provide views of a representation by rendering a proxy representation for a second viewpoint based on 3DGS data rendered from a first viewpoint in accordance with some implementations. In some implementations, the techniques of method 800 are performed on a mobile device, desktop, laptop, HMD, or server device. In some implementations, the method 800 is performed on processing logic, including hardware, firmware, software, or a combination thereof. In some implementations, the method 800 is performed on a processor executing code stored in a non-transitory computer-readable medium (e.g., a memory). In some implementations, the method 800 is implemented at a processor of a device, such as a viewing device, that renders a representation of an object, such as a user representation (e.g., device 210 of FIG. 2 renders 3D representation 240 of user 260 (a persona) from data obtained from device 265).

In particular, the method 800 provides views of a time-varying object that may be rendered from viewpoints that potentially vary over time, where the object is represented using a stream of 3D data having discretized volumetric form (e.g., a 30 Hz stream of 3D Gaussian splats point cloud data representing the object's changing appearance over time). Rendering the volumetric data (e.g., splats) directly may be computationally expensive and thus it may be inefficient or infeasible to re-render the object directly for different viewpoints at a fast rate (e.g., 90 Hz). To enable efficient rendering of volumetric data received at a first rate (e.g., 30 Hz) at a faster rate (e.g., 90 Hz), in an exemplary implementation, a 3D proxy representation (e.g., a textured 3D mesh, a textured heightfield, etc.) may be generated. A 3D proxy representation may be easier to render and a system can use the 3D proxy to render additional views needed to provide the views at the faster rate (e.g., for the second and third frames needed to provide views of 30 Hz content at 90 Hz) than using 3DGS techniques (e.g., as a technique to help with interpolation between frames).

At block 810, the method 800 obtains three-dimensional Gaussian Splat (3DGS) data representing an object, the 3DGS data including 3DGS datasets each using a plurality of splats having three-dimensional (3D) positions to represent the object at a respective time of a plurality of times associated with a first rate at which the 3DGS data was generated. In particular, a first 3DGS dataset corresponds to a first time of the plurality of times. For example, point clouds of gaussian splat datasets may be generated at a rate (e.g., 30 Hz or the like), and the splats of those datasets may include 3D Gaussian parameters such as, inter alia, 3D position, direction and angle information (e.g., cone of visibility), color (e.g., view dependent/harmonics information), covariance, alpha/transparency, orientation, opacity, extent in each axis, rotation, scale, semantic information (e.g., skin, hair, cheek, nose, lips, eyebrow, etc.), and the like. 3DGS is a technique where individual 3D points are represented as Gaussian distributions (e.g., splat parameter data, also referred to as “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, the device is a viewing device that renders a representation of the object, such as a user representation (e.g., a persona). In some implementations, the at least the portion of the object (e.g., a person) includes a face portion and an additional portion of the user (e.g., head, neck, clothes, hair, body, etc. of a user of sending device). In other words, the method 800 is at a viewer's device that provides a view of a representation of a sender based on data from a sender's device. In an exemplary implementation, a user representation (e.g., a persona) of the sender is provided for viewing, however, the techniques described herein (e.g., Gaussian splatting culling) may render any type of object or scene for reconstruction of viewing at the viewer's device.

In some implementations, the object representation data is based on UV maps and 3D point cloud points associated with distribution data defining sizes and shapes for rendering the 3D point cloud points as splats corresponding to each point of the UV maps (e.g., 3D Gaussian map). In some implementations, the splat parameter data includes 3D Gaussian parameters. For example, the splat parameter data may include position information (e.g., a 3D position), direction and angle information (e.g., a cone of visibility), color information, covariance information, transparency information, an orientation, opacity information, extent information in each axis, rotation data, a scale, and/or semantic information (e.g., skin, hair, cheek, nose, lips, eyebrow, etc.). For example, as illustrated in FIG. 6, the 3D Gaussian map process 630 generates 3D Gaussian Map data 632 (e.g., multiple sets of splat parameter data) by transforming the enrollment image data to multiple sets of feature data which may include learned feature information of a user obtained from the enrollment images, such as skin, color, and other semantic information per pixel. For example, a splat parameter position may identify where a splat is located based on xyz coordinates, a splat parameter covariance may identify how a splat is stretched/scaled (e.g., a 3×3 matrix), a splat parameter color may identify an RGB color, and a splat parameter alpha (α) may identify how transparent is the splat. In some implementations, the user representation data includes 3D point cloud points associated with distribution data defining sizes and shapes for rendering 3D point cloud points as splats. For example, a splat model generated using Gaussian splats that includes texture/color, position, splat shape, and the like. In some implementations, the user representation data includes 3D mapping information that includes feature values and position information for each map point (e.g., identifying x,y,z positions corresponding to UV coordinates of a UV map).

In some implementations, the splat generation technique includes a splat criterion associated with a resolution of each splat associated with each of the multiple sets of splats (e.g., a quality splat threshold). In some implementations, the splat generation technique includes a splat criterion associated with a quantity of splats associated with each of the multiple sets of splats (e.g., a number splat threshold such as 32 k vs 64 k). In some implementations, the splat generation technique includes a splat criterion associated with a size of each splat associated with each of the multiple sets of splats (e.g., a size splat threshold).

At block 820, the method 800 provides a first view depicting the object (e.g., at least a portion of) in a 3D environment, the first view corresponding to a first viewpoint in the 3D environment and splats of the first 3DGS dataset. This may involve generating the view by rendering the splats using their 3D positions. For example, as illustrated in FIG. 6, the 3DGS user representation 652 may be generated for a first viewpoint based on rendering the points from a Gaussian UV map 642. Alternatively, in some implementations, providing the first view may involve generating a 2D texture representing the appearance of the object from the first viewpoint and integrating that into a view of the 3D environment, and such a 2D texture may be used in the next step to create the proxy representation.

At block 830, the method 800 generates a proxy representation of the object based on a 2D texture and the 3D positions of splats associated with the first 3DGS dataset, the 2D texture generated based on the first 3DGS dataset and corresponding to an appearance of the object from the first viewpoint in a 3D environment. The proxy representation may be a proxy mesh, a heightfield, and the like. For example, this may involve generating a first texture from a first/current 3DGS point cloud that is used as a view for a first time (e.g., a first frame), and generating a 3D proxy using a mapped 2D texture. In some implementations, the 3D proxy may be generated (e.g., recreated) based on each new 3DGS frame that's generated.

The selection of the proxy rendering approach may depend upon rendering complexity and/or viewpoint movement. In some implementations, generating the proxy representation of the object includes selecting a proxy rendering approach based on determining a complexity level associated with rendering a view of the object. In some implementations, selecting the proxy rendering approach is based on determining at least one of a proxy type (e.g., mesh, heightfield) and a proxy format (stereo grid mesh, mono grid mesh, stereo planes, mono plane, etc.) for depicting the proxy representation. For example, a proxy rendering approach may be selected as a mesh, a heightfield, a mono grid, stereo planes, a mono plane, and the like. In some implementations, the proxy representation is generated based on the second viewpoint (e.g., apply the 2D texture in the 3D space based on the current viewpoint).

At block 840, the method 800 provides a second view depicting the object in the 3D environment, the second view being provided by depicting the proxy representation from a second viewpoint in the 3D environment, and the first view and the second view provide views of the object in the 3D environment at a second rate that is faster than the first rate at which the 3DGS data was generated. In other words, if the intended display frame rate is 90 hz, but the splat data is generated at 30 hz, the proxy representations may be rendered at 90 hz for the additional viewpoints. For example, as illustrated in FIG. 6, user representations 672, 674, etc., are generated for particular viewpoints based on rendering the proxy representations 662, 664, etc.

In some implementations, the method 800 further includes updating the proxy representation of the object based on image quality associated with the second view depicting the object in the 3D environment. For example, regenerate the proxy representation if too much noise or a poor quality rendering is detected (e.g., detecting artifacts in the persona rendering). In some implementations, the method 800 further includes updating the proxy representation of the object based on detecting motion of the device with respect to a movement threshold. For example, regenerate the representation of the object based on detecting too much motion (e.g., a quick turn of the viewer's head there may be artifacts. In some implementations, the generated proxy representation of the object includes a first eye representation and a second eye representation (e.g., stereo view so there are two different meshes per eye which may be important for depth).

In some implementations, the proxy representation of the object is generated based on one or more proxy parameters corresponding to a proxy generation technique (e.g., in view of the complexity of a particular rendering). In some implementations, the one or more proxy parameters corresponding to the proxy generation technique includes a proxy criterion associated with a resolution of the proxy representation of the object. For example, one proxy parameter setting may include proxy PPD to select a resolution of the proxy. In some implementations, the one or more proxy parameters corresponding to the proxy generation technique includes one or more proxy levels. In some implementations, the one or more proxy levels include a stereo grid mesh, a stereo plane, a mono grid mesh, and a mono plane. For example, another proxy parameter setting may include proxy levels to determine whether to use a stereo grid mesh (FIG. 5A), a stereo plane (FIG. 5B), a mono grid mesh (FIG. 5C), a mono plane (FIG. 5D), and the like. In some implementations, the one or more proxy parameters corresponding to the proxy generation technique includes a proxy criterion associated with a proxy update rate corresponding to the second rate. For example, another proxy parameter setting may include a proxy update rate to update the proxy at lower or higher frame rates (e.g., greater than or less than the display frame rate).

In various implementations, the proxy representation is a 3D mesh. In some implementations, the method 800 further includes adjusting a density of a set of vertices in at least a portion of the 3D mesh based on a gaze direction. In other words, adjusting the density of vertices to control vertex sensitivity of the mesh to focus on where a viewer is gazing (e.g., as you get further away from a gaze center, then less vertex sensitivity is needed). For example, as illustrated in FIGS. 7A-7C, vortex animation may be adjusted based on determining a gaze center (e.g., looking at a view of a face of the user representation 715). Based on the determining the center of a gaze of a viewer (e.g., user 110), then more vertices may be added at the center of the gaze and project that on a persona. In some implementations, the 3D proxy mesh is not adding a vertex, but the vertices may be warped more towards the gaze center, as illustrated in FIG. 7C. For example, since there are a million pixels for personas, this process may reduce those calculations such that in between regions of grid, and the system may perform some linear interpolation (or other technique/calculation) to determine what the value should be in those areas.

In some implementations, providing the second view of the object in the 3D environment by depicting the proxy representation in the 3D environment is based on a variable resolution map, wherein a first portion of the second view of the object is a different resolution than a second portion of the second view. For example, a variable map may be used for generating the proxy representation that includes a density of pixels which is not uniform, so different rendering resolutions may be used in different areas for rendering the proxy representation.

In various implementations, the 3DGS user representation 652 may be reused (e.g., rerendered) in subsequent frames if the characteristic (e.g., viewpoint) does not change. In some implementations, the view of the representation is provided for a first frame of a plurality of frames for a first viewpoint, and the method 800 further includes, for a second viewpoint for a second frame of the plurality of frames, determining that the second viewpoint is equivalent to the first viewpoint, and reusing the view of the representation of the at least the portion of the object from the first frame for the second frame (e.g., based on the selected splat approach form the first frame). Additionally, or alternatively, in some implementations, the view of the representation is provided for a first frame of a plurality of frames for a first viewpoint, the method further 800 further including, for a second viewpoint for a second frame of the plurality of frames determining that the second viewpoint is different than the first viewpoint, and updating the view of the representation of the at least the portion of the object based on using a proxy representation.

In various implementations, the method 800 further includes modifying representation data based on obtaining a set of sensor data obtained after an enrollment process. For example, modifying the splat parameter data based on live data (e.g., for displaying a persona of a user). For example, the splat parameter data may be obtained from a sending device such as from an enrollment process, and the modifications to the enrollment splat parameter data may be based on obtaining live sensor of the sender in order to determine a live representation of the sender (e.g., a live view of a realistic persona for a communication session). In some implementations, modifying the user representation data generates 3D Gaussian splats based on the image data for the at least the portion of the user, where the Gaussian splats include a texture, a position, and a splat shape. For example, a 3D Gaussian distribution in 2D space with color/density, e.g., parameterization where a face is represented as a grid, and the system determines a number or splats per ray off the face/grid. In some implementations, the splat generation technique generates the 3DGS data and/or the representation of the object via a machine learning model trained using training data obtained via one or more sensors in one or more environments. For example, a machine learning model that interprets the image data and/or other sensor data captured during an enrollment phase or other process.

In various implementations, the representation may be a user representation (e.g., a persona), and the user representation may be modified for a face and not the body, for a body and not the face, both the body and face, and/or may be modified either during an enrollment phase, on a sender side device and/or on a receiver side device. In other words, the user representation (persona) may be continuously updated to represent a live view of a current user's head/face and/or upper body movements and may be modified at different stages during a communication session. In some implementations, a splat rendering and/or proxy rendering approach associated with user representation data is modified based on body pose data obtained during the enrollment process, during a communication session with another device, or a combination thereof. In some implementations, the device is a viewer's device, and the splat rendering and/or proxy rendering approach associated with the user representation data is modified based on an additional set of sensor data obtained during a communication session with a sender's device associated with the user representation. Alternatively, in some implementations, the splat rendering and/or proxy rendering approach associated with the representation is generated and updated during the enrollment process based on images of a face of the user captured while the user is expressing a plurality of different facial expressions (e.g., enrollment images of the face while the user is smiling, brows raised, cheeks puffed out, etc.).

In some implementations, the second set of sensor data obtained after the enrollment process by the device (e.g., a viewer's device) includes a sequence of frames for a Gaussian UV Map and corresponding marker points. The sequence of frames for the Gaussian UV Map and corresponding marker points may be obtained during a communication session from a second device (e.g., a sender's device). The device (e.g., a viewer's device) renders an animated depiction of the user (e.g., a sender) based on the sequence of frames for a Gaussian UV Map and corresponding marker points using one or more splatting techniques described herein. For example, the set of Gaussian UV Map and corresponding marker points sent during a communication session with a second device may be used to render a view of the face (and upper body) of the user (sender). Additionally, or alternatively, sequential frames of face data (appearance of the user's face at different points in time) and body tracking data may be transmitted and used to display a live 3D video-like depiction of the user (e.g., a “live” persona).

In some implementations, the second user representation is based on second image data obtained via a second set of sensors in a second physical environment having a second lighting condition (e.g., different lighting condition than the first physical environment). For example, during an enrollment process, the user representation data is acquired in a particular environment (also referred to herein as an “enrollment environment”) that includes some lighting conditions information (e.g., luminance values and other lighting attributes), which may be different lighting data than live lighting data (e.g., two different physical environments between enrollment and during the generation of the persona based on “live” sensor data). In some implementations, providing the first view and the second view for depicting the object in the 3D environment includes displaying the representation in a 3D environment, such as an extended reality (XR) environment.

In some implementations, the method 800 further includes modifying the view of the user representation by adjusting the user representation based on at least one color attribute of a plurality of color attributes of an environment, at least one light attribute of a plurality of light attributes of the environment, or a combination thereof. For example, adjusting a color or lighting on the user representation, such as the hair, face, clothing, and the like, based on a color and/or light associated with the viewer's environment and/or with the sender's environment. In other words, the lighting and/or color of a 3D representation (e.g., persona) may be altered to match the lighting and/or color of a viewer's environment (e.g., a reddish hue of light shining in a viewer's room would be reflected on the 3D representation). Alternatively, the lighting and/or color of a 3D representation (e.g., persona) may be altered to match the lighting and/or color of a sender's environment (e.g., a greenish hue of light shining in a sender's room would be reflected on the 3D representation to a viewer, even though the enrollment data did not reflect the greenish hue of light).

In some implementations, the user representation data of at least a portion of a user that is obtained during an enrollment process is based on images of a face of the user captured in different poses, and/or while the user is expressing a plurality of different facial expressions. For example, the images are enrollment images of the face while the user is facing toward the camera, to the left of the camera, and to the right of the camera, and/or while the user is smiling, brows raised, cheeks puffed out, etc. For example, as illustrated by enrollment process 610 of FIG. 6, enrollment images 612 of the face may be obtained while the user is smiling, brows raised, cheeks puffed out, etc. from different viewpoints. In some implementations, the first set of sensor data corresponds to only a first area of the user (e.g., parts not obstructed by the device, such as an HMD), and the second set of sensor data corresponds to a second area including a third area different than the first area. For example, a second area may include some of the parts obstructed by an HMD when it is being worn by the user. For example, during an enrollment process, a larger portion of a user may be captured by image data (e.g., not wearing the HMD), than during a live communication session with the user wearing the HMD.

In some implementations, as illustrated in FIG. 2, the rendering occurs during a communication session in which a second device (e.g., device 265) captures sensor data (e.g., image data of user 260 and a portion of the environment 250) and provides a sequence of frame-specific 3D representations corresponding to the multiple instants in the period time based on the sensor data. For example, the second device 265 provides/transmits the sequence of frame-specific 3D representations to device 210, and device 210 generates the combined 3D representation to display a live 3D video-like face depiction (e.g., a realistic moving persona) of the user 260 (e.g., representation 240 of user 260). Alternatively, in some implementations, the second device provides the 3D representation of the user (e.g., representation 140 of user 260) during the communication session (e.g., a realistic moving persona). For example, the combined representation is determined at device 265 and sent to device 210. In some implementations, the views of the 3D representations are displayed on the device (e.g., device 210) in real-time relative to the multiple instants in the period of time. For example, the depiction of the user is displayed in real-time and based on live lighting data (e.g., a persona shown to a second user on a display of a second device of the second user).

In some implementations, the view of the user representation may include sufficient data to enable a stereo view of the user (e.g., left/right eye views) such that the face may be perceived with depth. In one implementation, a depiction of a face includes a 3D model of the face and views of the representation from a left eye position and a right eye position and are generated to provide a stereo view of the face.

In some implementations, certain parts of the face that may be of importance to conveying a realistic or honest appearance, such as the eyes and mouth, may be generated differently than other parts of the face (e.g., based on marker points). For example, parts of the face that may be of importance to conveying a realistic or honest appearance may be based on current camera data while other parts of the face may be based on previously-obtained (e.g., enrollment) face data.

In some implementations, a representation of a face is generated with texture, color, and/or geometry for various face portions identifying an estimate of how confident the generation technique is that such textures, colors, and/or geometries accurately correspond to the real texture, color, and/or geometry of those face portions based on the depth values and appearance values each frame of data. In some implementations, the depiction is a 3D persona. For example, the representation is a 3D model that represents the user (e.g., user 110 of FIG. 1).

In some implementations, the first set of sensor data and/or the second set of sensor data (e.g., live data, such as video content that includes light intensity data (RGB) and depth data), is associated with a point in time, such as images from inward/down facing sensors while the user is wearing an HMD associated with a frame. In some implementations, the sensor data includes depth data (e.g., infrared, time-of-flight, etc.) and light intensity image data obtained during a scanning process.

In some implementations, obtaining the first set of sensor data during an enrollment process may include obtaining enrollment sensor data corresponding to features (e.g., texture, muscle activation, shape, depth, etc.) of a face of a user in a plurality of configurations from a device (e.g., enrollment image data 612 of FIG. 6). In some implementations, the first set of data includes unobstructed image data of the face of the user. For example, images of the face may be captured while the user is smiling, brows raised, cheeks puffed out, etc. In some implementations, enrollment data may be obtained by a user taking the device (e.g., an HMD) off and capturing images without the device occluding the face or using another device (e.g., a mobile device) without the device (e.g., HMD) occluding the face. In some implementations, the enrollment data (e.g., the first set of data) is acquired from light intensity images (e.g., RGB image(s)). The enrollment data may include textures, muscle activations, etc., for most, if not all, of the user's face. In some implementations, the enrollment data may be captured while the user is provided different instructions to acquire different poses of the user's face. For example, the user may be instructed by a user interface guide to “raise your eyebrows,” “smile,” “frown,” etc., in order to provide the system with a range of facial features for an enrollment process.

In some implementations, the method 800 may be repeated for each frame captured during each instant/frame of a live communication session or other experience. For example, for each iteration, while the user is using the device (e.g., wearing the HMD), the method 800 may involve continuously obtaining live sensor data (e.g., face tracking data, body tracking, and the like), and for each frame, updating the selected subset of splat parameter data based on updated viewing characteristics (e.g., FoV, gaze, occlusions, etc.) for that frame, and update the displayed portions of the user representation based on the updated Gaussian data. For example, for each new frame, the system can update the display of the 3D persona based on the new data.

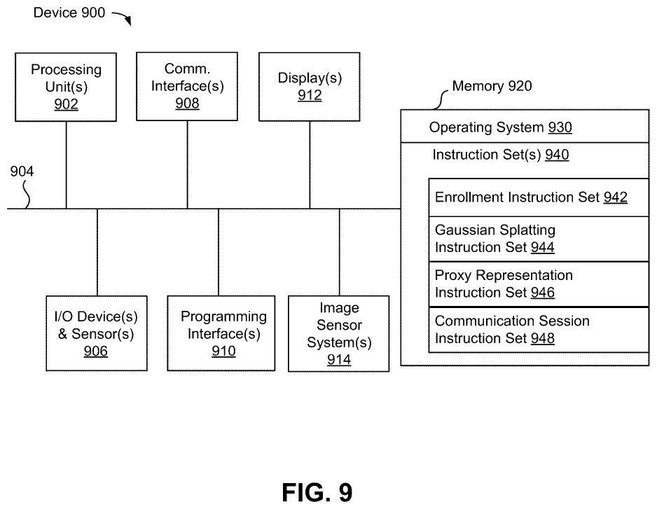

FIG. 9 is a block diagram of an example device 900. Device 900 illustrates an exemplary device configuration for devices described herein (e.g., devices 105, 210, 265, 410, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 900 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more displays 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 912 are configured to present a view of a physical environment or a graphical environment to the user. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 912 correspond to diffractive, reflective, polarized, holographic, etc. waveguide displays. In one example, the device 10 includes a single display. In another example, the device 10 includes a display for each eye of the user.

In some implementations, the one or more image sensor systems 914 are configured to obtain image data that corresponds to at least a portion of the physical environment 102. For example, the one or more image sensor systems 914 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 includes a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of electrical charge. In some implementations, the instruction set(s) 940 are software that is executable by the one or more processing units 902 to carry out one or more of the techniques described herein.

The instruction set(s) 940 include an enrollment instruction set 942, a Gaussian splatting instruction set 944, a proxy representation instruction set 946, and a communication session instruction set 948. The instruction set(s) 940 may be embodied a single software executable or multiple software executables.

In some implementations, the enrollment instruction set 942 is executable by the processing unit(s) 902 to generate enrollment data from image data. The enrollment instruction set 942 may be configured to provide instructions to the user in order to acquire image information to generate the enrollment personification (e.g., enrollment image data 612) and determine whether additional image information is needed to generate an accurate enrollment personification to be used by the persona display process. To these ends, in various implementations, the instruction includes instructions and/or logic therefor, and heuristics and metadata therefor.

In some implementations, the Gaussian splatting instruction set 944 is executable by the processing unit(s) 902 to generate a representation of an object such as a user representation (e.g., rendering via a Gaussian splatting technique) by using one or more of the techniques discussed herein or as otherwise may be appropriate. To these ends, in various implementations, the instruction includes instructions and/or logic therefor, and heuristics and metadata therefor.

In some implementations, the proxy representation instruction set 946 is executable by the processing unit(s) 902 to generate a proxy representation of an object such as a user representation (e.g., rendering via a meshing technique) by using one or more of the techniques discussed herein or as otherwise may be appropriate. In some implementations, the proxy representation instruction set 946 is executable by the processing unit(s) 902 to analyze and select a mesh for use in providing a view for a different viewpoint as discussed herein or as otherwise may be appropriate. To these ends, in various implementations, the instruction includes instructions and/or logic therefor, and heuristics and metadata therefor.

In some implementations, the communication session instruction set 948 is executable by the processing unit(s) 902 to facilitate a communication session between two or more electronic devices (e.g., device 210 and device 265 as illustrated in FIG. 2) using one or more of the techniques discussed herein or as otherwise may be appropriate. To these ends, in various implementations, the instruction includes instructions and/or logic therefor, and heuristics and metadata therefor.

Although the instruction set(s) 940 are shown as residing on a single device, it should be understood that in other implementations, any combination of the elements may be located in separate computing devices. Moreover, FIG. 9 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

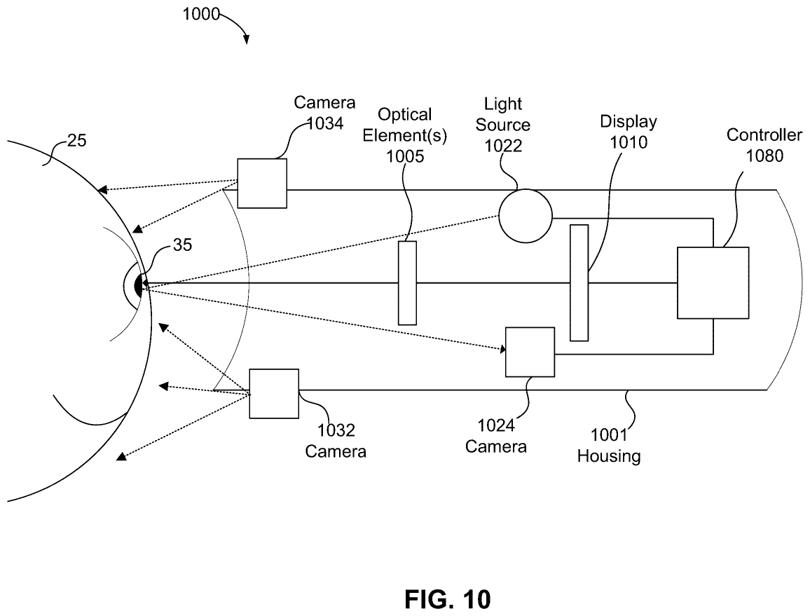

FIG. 10 illustrates a block diagram of an exemplary head-mounted device 1000 in accordance with some implementations. The head-mounted device 1000 includes a housing 1001 (or enclosure) that houses various components of the head-mounted device 1000. The housing 1001 includes (or is coupled to) an eye pad (not shown) disposed at a proximal (to the user 25) end of the housing 1001. In various implementations, the eye pad is a plastic or rubber piece that comfortably and snugly keeps the head-mounted device 1000 in the proper position on the face of the user 25 (e.g., surrounding the eye 35 of the user 25).

The housing 1001 houses a display 1010 that displays an image, emitting light towards or onto the eye of a user 25. In various implementations, the display 1010 emits the light through an eyepiece having one or more optical elements 1005 that refracts the light emitted by the display 1010, making the display appear to the user 25 to be at a virtual distance farther than the actual distance from the eye to the display 1010. For example, optical element(s) 1005 may include one or more lenses, a waveguide, other diffraction optical elements (DOE), and the like. For the user 25 to be able to focus on the display 1010, in various implementations, the virtual distance is at least greater than a minimum focal distance of the eye (e.g., 7 cm). Further, in order to provide a better user experience, in various implementations, the virtual distance is greater than 1 meter.

The housing 1001 also houses a tracking system including one or more light sources 1022, camera 1024, camera 1032, camera 1034, and a controller 1080. The one or more light sources 1022 emit light onto the eye of the user 25 that reflects as a light pattern (e.g., a circle of glints) that can be detected by the camera 1024. Based on the light pattern, the controller 1080 can determine an eye tracking characteristic of the user 25. For example, the controller 1080 can determine a gaze direction and/or a blinking state (eyes open or eyes closed) of the user 25. As another example, the controller 1080 can determine a pupil center, a pupil size, or a point of regard. Thus, in various implementations, the light is emitted by the one or more light sources 1022, reflects off the eye of the user 25, and is detected by the camera 1024. In various implementations, the light from the eye of the user 25 is reflected off a hot mirror or passed through an eyepiece before reaching the camera 1024.

The display 1010 emits light in a first wavelength range and the one or more light sources 1022 emit light in a second wavelength range. Similarly, the camera 1024 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 1010 by looking at it), provide foveated rendering (e.g., present a higher resolution in an area of the display 1010 the user 25 is looking at and a lower resolution elsewhere on the display 1010), or correct distortions (e.g., for images to be provided on the display 1010). In various implementations, the one or more light sources 1022 emit light towards the eye 35 of the user 25 which reflects in the form of a plurality of glints.

In various implementations, the camera 1024 is a frame/shutter-based camera that, at a particular point in time or multiple points in time at a frame rate, generates an image of the eye 35 of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1024 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1032 and camera 1034 are frame/shutter-based cameras that, at a particular point in time or multiple points in time at a frame rate, can generate an image of the face of the user 25. For example, camera 1032 captures images of the user's face below the eyes, and camera 1034 captures images of the user's face above the eyes. The images captured by camera 1032 and camera 1034 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
obtaining three-dimensional Gaussian Splat (3DGS) data representing an object, wherein the 3DGS data comprises 3DGS datasets each using a plurality of splats having three-dimensional (3D) positions to represent the object at a respective time of a plurality of times associated with a first rate at which the 3DGS data was generated, wherein a first 3DGS dataset corresponds to a first time of the plurality of times;
providing a first view depicting the object in a 3D environment, the first view corresponding to a first viewpoint in the 3D environment and splats of the first 3DGS dataset;
generating a proxy representation of the object based on a two-dimensional (2D) texture and the 3D positions of splats associated with the first 3DGS dataset, the 2D texture generated based on the first 3DGS dataset and corresponding to an appearance of the object from the first viewpoint in a 3D environment; and
providing a second view depicting the object in the 3D environment, wherein the second view is provided by depicting the proxy representation from a second viewpoint in the 3D environment, wherein the first view and second view provide views of the object in the 3D environment at a second rate that is faster than the first rate at which the 3DGS data was generated.

2. The method of claim 1, wherein generating the proxy representation of the object comprises selecting a proxy rendering approach based on determining a complexity level associated with rendering a view of the object.

3. The method of claim 2, wherein selecting the proxy rendering approach is based on determining at least one of a proxy type and a proxy format for depicting the proxy representation.

4. The method of claim 1, wherein the proxy representation is generated based on the second viewpoint.

5. The method of claim 1, wherein the proxy representation is a 3D mesh.

6. The method of claim 1, further comprising:
adjusting a density of a set of vertices in at least a portion of the 3D mesh based on a gaze direction.

7. The method of claim 1, further comprising:
updating the proxy representation of the object based on image quality associated with the second view depicting the object in the 3D environment.

8. The method of claim 1, further comprising:
updating the proxy representation of the object based on detecting motion of the device with respect to a movement threshold.

9. The method of claim 1, wherein the generated proxy representation of the object comprises a first eye representation and a second eye representation.

10. The method of claim 1, wherein the proxy representation of the object is generated based on one or more proxy parameters corresponding to a proxy generation technique.

11. The method of claim 10, wherein the one or more proxy parameters corresponding to the proxy generation technique comprises a proxy criterion associated with a resolution of the proxy representation of the object.

12. The method of claim 10, wherein the one or more proxy parameters corresponding to the proxy generation technique comprises one or more proxy levels, wherein the one or more proxy levels include a stereo grid mesh, a stereo plane, a mono grid mesh, and a mono plane.

13. The method of claim 10, wherein the one or more proxy parameters corresponding to the proxy generation technique comprises a proxy criterion associated with a proxy update rate corresponding to the second rate.

14. The method of claim 1, wherein providing the second view of the object in the 3D environment by depicting the proxy representation in the 3D environment is based on a variable resolution map, wherein a first portion of the second view of the object is a different resolution than a second portion of the second view.

15. The method of claim 1, wherein the object comprises a face portion and an additional portion of a user.

16. The method of claim 1, wherein providing the first view depicting the object is based on 3D point cloud points associated with distribution data defining sizes and shapes for rendering the 3D point cloud points as the splats of the first 3DGS dataset.

17. The method of claim 1, wherein the device is a viewer's device, wherein the 3DGS data is obtained during a communication session with a sender's device associated with the proxy representation of the object.

18. The method of claim 1, wherein the 3DGS data is obtained in a first physical environment, and the views depicting the object in the 3D environment is displayed in a view of a second physical environment that is different than the first physical environment.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining three-dimensional Gaussian Splat (3DGS) data representing an object, wherein the 3DGS data comprises 3DGS datasets each using a plurality of splats having three-dimensional (3D) positions to represent the object at a respective time of a plurality of times associated with a first rate at which the 3DGS data was generated, wherein a first 3DGS dataset corresponds to a first time of the plurality of times;
providing a first view depicting the object in a 3D environment, the first view corresponding to a first viewpoint in the 3D environment and splats of the first 3DGS dataset;
generating a proxy representation of the object based on a two-dimensional (2D) texture and the 3D positions of splats associated with the first 3DGS dataset, the 2D texture generated based on the first 3DGS dataset and corresponding to an appearance of the object from the first viewpoint in a 3D environment; and
providing a second view depicting the object in the 3D environment, wherein the second view is provided by depicting the proxy representation from a second viewpoint in the 3D environment, wherein the first view and second view provide views of the object in the 3D environment at a second rate that is faster than the first rate at which the 3DGS data was generated.

20. A non-transitory computer-readable storage medium, storing program instructions executable on a device to perform operations comprising:
obtaining three-dimensional Gaussian Splat (3DGS) data representing an object, wherein the 3DGS data comprises 3DGS datasets each using a plurality of splats having three-dimensional (3D) positions to represent the object at a respective time of a plurality of times associated with a first rate at which the 3DGS data was generated, wherein a first 3DGS dataset corresponds to a first time of the plurality of times;
providing a first view depicting the object in a 3D environment, the first view corresponding to a first viewpoint in the 3D environment and splats of the first 3DGS dataset;
generating a proxy representation of the object based on a two-dimensional (2D) texture and the 3D positions of splats associated with the first 3DGS dataset, the 2D texture generated based on the first 3DGS dataset and corresponding to an appearance of the object from the first viewpoint in a 3D environment; and
providing a second view depicting the object in the 3D environment, wherein the second view is provided by depicting the proxy representation from a second viewpoint in the 3D environment, wherein the first view and second view provide views of the object in the 3D environment at a second rate that is faster than the first rate at which the 3DGS data was generated.
